(19) United States
(12) Patent Application Publication
(10) Pub. No.: US 2019/0126217 A1
(43) Pub. Date: May 2, 2019

(54) AGITATOR MOUNTING ASSEMBLY

(71) Applicant: Woodman Agitator, Avon, OH (US)

(72) Inventor: Keith Bielozer, Avon, OH (US)

(21) Appl. No.: 15/797,517

(22) Filed: Oct. 30, 2017

(51) Int. Cl. B01F 7/16; B01F 7/00; B01F 7/22

(52) U.S. Cl. CPC B01F 7/1695; B01F 2215/005; B01F 7/22; B01F 7/00725

(57) ABSTRACT

An agitator mounting assembly is provided for hanging an agitator relative to a container for enabling rotation of the agitator to agitate fluid in a container. The agitator mounting assembly is configured to align the agitator both radially relative to and longitudinally along a central longitudinal container axis of the container. The agitator mounting assembly includes an annular base member and a coupling member that cooperatively engage one another to hang the agitator in the container. The annular base member is removably couplable to the container and provides for access to a shaft of the agitator disposed in the container. The coupling member is removably couplable to the shaft and is supported by the annular base member when coupled to the shaft to thereby support the hanging of the agitator from the agitator mounting assembly.

### FIELD OF INVENTION

The present invention relates generally to an agitator being incorporated into a container for agitating liquids and liquid suspensions in the container, and more particularly to an agitator mounting assembly for positioning and supporting the agitator for rotation relative to the container.

### BACKGROUND

Large quantities of fluids, such as paints and other liquid mixtures, are often stored in large containers having a cylindrical side wall and circular head and bottom walls. Such a container is commonly called a drum, with the walls commonly being formed from sheet metal such as steel. One typical size is a 50-gallon drum.

Liquids and liquid suspensions stored in such containers are often mixed or agitated using a bladed agitating device. The bladed agitating device, called an agitator, can be mounted relative to the container, such as to one or both of the circular head wall and the circular bottom wall. This mounting supports the agitator during rotation thereof to agitate the fluid therein. The agitator can be controlled by a powered or unpowered motive device that is configured for causing movement, such as rotation, of the agitating device.

### SUMMARY OF INVENTION

The present invention provides an agitator mounting assembly for hanging an agitator relative to a container. The hanging enables rotation of the agitator to agitate fluid in the container. The agitator mounting assembly is configured to align the agitator both radially and longitudinally relative to a central longitudinal container axis of the container. Further, the agitator is radially supported during rotation by the agitator mounting assembly to restrict radial and angular deviation of the agitator relative to the central longitudinal axis.

An exemplary agitator mounting assembly is couplable to a container for mounting an agitator in the container. The agitator mounting assembly includes an annular base member being removably couplable to the container and providing for access to a shaft of the agitator disposed in the container. The agitator mounting assembly also includes a coupling member removably couplable to the shaft, the coupling member being supported by the annular base member when coupled to the shaft to thereby support hanging of the agitator from the agitator mounting assembly.

The annular base member may have a cavity extending fully therethrough along a longitudinal base member axis, an elongated lower portion of the cavity having a continuous circular cross-section of constant diameter along a length of the longitudinal base member axis that is at least twice a diameter of the lower portion of the cavity to radially support a length of the shaft received therein.

The annular base member may include an annular internal wall defining an elongated cavity extending therethrough for receiving and supporting the shaft, and the annular internal wall may be configured to radially engage a length of the shaft received therein that is axially spaced from a proximal end of the shaft couplable to the coupling member to serve as a bearing surface for said length of the shaft.

The hanging may include aligning the shaft of the agitator along a longitudinal base member axis of the annular base member.

The annular base member may have an internal bearing surface against which the coupling member is engaged for supporting rotation of the coupling member with the agitator when the coupling member is coupled to the agitator.

The annular base member may be configured to receive and to retain the coupling member completely within a cavity of the annular base member.

The coupling member may include a pin portion configured to be received into a corresponding slot of the shaft for retaining the shaft relative to the coupling member.

The coupling member may include a pair of oppositely disposed sections engageable with one another with the shaft disposable therebetween for retaining the shaft relative to the coupling member.

The annular base member may be a single molded article of unitary construction.

The agitator mounting assembly may be in combination with the agitator and the container, wherein the coupling member is attached to the shaft of the agitator and the coupling member is retained by the annular base member, and wherein the annular base member and coupling member are jointly configured to align the agitator along a central longitudinal container axis of the container.

Another exemplary agitator mounting assembly is couplable to a container for mounting an agitator in the container. The agitator mounting assembly includes an annular base member having a cavity extending fully therethrough along a longitudinal base member axis, the annular base member being removably couplable to the container and shaped to receive a shaft of the agitator therein. The agitator mounting assembly further includes a coupling member removably couplable to the shaft of the agitator and receivable into the cavity of the annular base member, wherein the annular base member has an inner support surface at least partially defining the cavity, wherein the inner support surface is located for engagement by the coupling member to support the coupling member during rotation with the shaft, and wherein the shaft is axially aligned along the longitudinal base member axis. An interengagement of the shaft with the coupling member and the coupling member with the annular base member aligns the agitator along the longitudinal base member axis such that the agitator may be offset from a lower surface of the container.

The annular base member may have a distal section received into the container that at least partially defines the cavity, wherein an elongated portion of the cavity defined by the distal section may be a cylindrical passage engageable by the shaft of the agitator to provide a longitudinal bearing surface having a greater length than a diameter of the cylindrical passage.

The annular base member cavity may include a proximal section receiving the coupling member and a distal section adjacent the proximal section, the distal section and the proximal section each receiving the shaft, wherein a cross-sectional area of the upper section orthogonal to the longitudinal base member axis and taken through a portion receiving the shaft is greater than a cross-sectional area of the lower section orthogonal to the longitudinal base member axis and taken through a portion receiving the shaft.

The coupling member may include a pin portion configured to be received into a corresponding slot of the shaft for retaining the shaft relative to the coupling member.

The coupling member may include a pair of oppositely disposed sections engageable with one another with the shaft disposed therebetween for retaining the shaft relative to the coupling member.

The cavity of the annular base member may be configured such that the coupling member is positioned within the container.

The annular base member may be a single molded article of unitary construction.

The agitator mounting assembly may be in combination with the agitator and the container, wherein the coupling member is attached about the shaft of the agitator and the coupling member is retained within the annular base member, and wherein the annular base member and coupling member are interengageable to align the agitator along a central longitudinal container axis of the container.

An exemplary method of mounting an agitator to a container using an agitator mounting assembly having an annular base member and a coupling member receivable into the annular base member is provided. The method includes the steps of threadedly coupling the annular base member to the container, receiving a proximal end of a shaft of the agitator into the annular base member, coupling the coupling member about the proximal end of the shaft of the agitator and into a slot of the shaft, and supporting the coupling member against a support surface of an internal cavity of the annular base member, thereby enabling the shaft coupled thereto to be hung relative to the annular base member.

The hanging of the shaft relative to the annular base member may include hanging the shaft spaced from a lower surface of the drum for rotation of the agitator while spaced from the lower surface.

The foregoing and other features of the invention are hereinafter fully described and particularly pointed out in the claims, the following description and annexed drawings setting forth in detail certain illustrative embodiments of the invention, these embodiments being indicative, however, of but a few of the various ways in which the principles of the invention may be employed.

### BRIEF DESCRIPTION OF THE DRAWINGS

The annexed drawings, which are not necessarily to scale, show various aspects of the disclosure.

FIG. 1 is a side view partly in cross-section of a container assembly including a container and an agitator, and further including an agitator mounting assembly in accordance with the present invention.

FIG. 2 is an enlarged partial view of the container assembly of FIG. 1, in combination with a powered motive device.

FIG. 3 is another enlarged partial view of the container assembly of FIG. 1.

FIG. 4 is an isometric view of the agitator mounting assembly shown in FIG. 1, depicted apart from the agitator and the container.

FIG. 5 is a cross-sectional view of the agitator mounting assembly of FIG. 4.

FIG. 6 is a side view of a coupling member of the agitator mounting assembly of FIGS. 1 and 4, shown separated from a shaft of the agitator of FIG. 1.

FIG. 7 is another side view of a coupling member of the agitator mounting assembly of FIG. 6, again shown separated from the shaft of the agitator of FIG. 1.

FIG. 8 is an isometric view of a coupling member of the agitator mounting assembly of FIG. 6, shown partially engaged with the shaft of the agitator of FIG. 1.

FIG. 9 is an isometric view of a coupling member of the agitator mounting assembly of FIG. 6, shown fully engaged with the shaft of the agitator of FIG. 1.

### DETAILED DESCRIPTION

The principles of the present disclosure have general application to an agitator mounting assembly for mounting an agitator for agitating fluids, such as liquids and liquid suspensions. The principles of the present disclosure have more particular application to mounting of such an agitator for agitation of a fluid surface coating stored in a large container, such as a drum. Such an agitator and associated mounting assembly may be suitable for the agitation of stains or thixotropic liquid surface coatings such as paints or floor coatings, for example. The agitator also may be suitable for agitation of waste products, cement, multi-part suspensions requiring agitation for activation, etc.

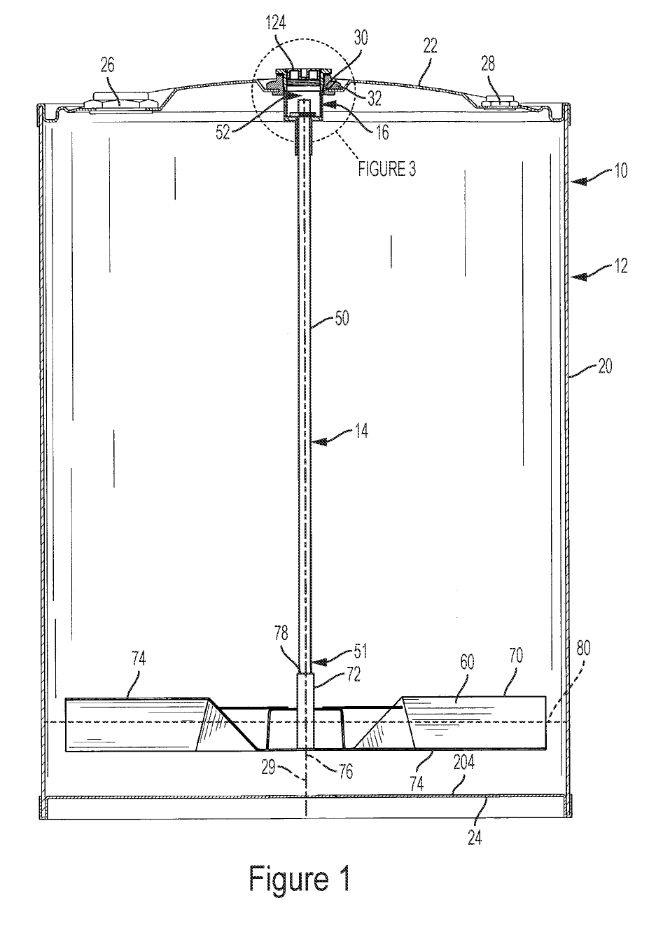

Referring now to the drawings and initially to FIG. 1, a container assembly 10 according to the present invention is depicted. The container assembly 10 includes a container, such as a drum 12, an agitator 14 disposed in the drum 12 for agitating fluids located within the drum 12, and an attachment mechanism, such as an agitator mounting assembly 16 for mounting and supporting the agitator 14 relative to the drum 12.

A motive device 18 is depicted in combination with the container assembly 10 for causing rotation of the agitator 14 relative to the drum 12. The motive device 18 may be any suitable powered or unpowered device for transferring rotational motion of a component of the motive device 18 to the agitator 14. For example, the motive device 18 may include a motor. In other embodiments, the motive device may be a handle that is attachable to the agitator 14 for allowing manual rotation of the agitator 14 relative to the agitator mounting assembly 16 and relative to the drum 12.

The illustrated drum 12 includes a side wall, such as a cylindrical side wall 20. A circular upper head wall 22 and a circular bottom wall 24 are oppositely disposed at opposite axial sides of the cylindrical side wall 20. The head wall 22 and bottom wall 24 are sized to correspond to a desired drum capacity, such as a fifty gallon, fifty-five gallon, or thirty gallon capacity. The illustrated side wall 20, head wall 22, and bottom wall 24 are composed of sheet metal, such as steel, though other materials such as plastic may be used.

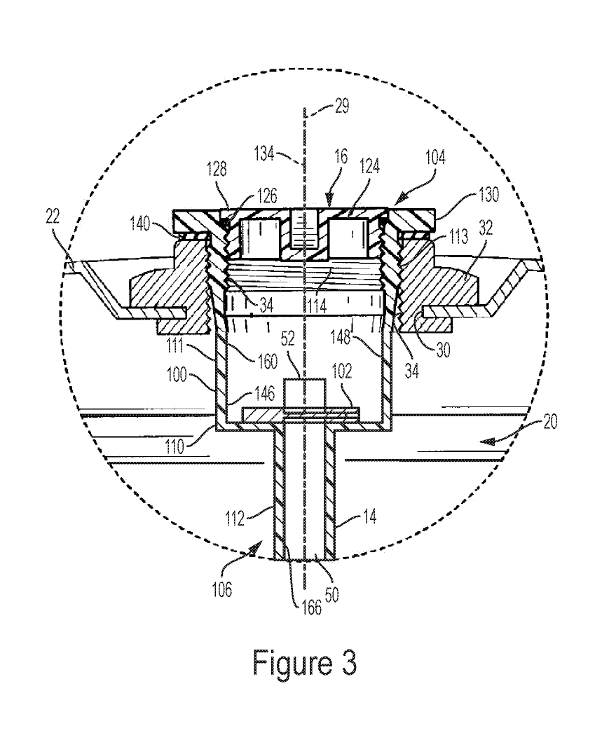

The depicted head wall 22 has a pair of oppositely disposed openings 26 and 28, which may be otherwise located relative to one another in other embodiments. The depicted fill opening 26 and vent opening 28 are disposed at opposite sides of the head wall 22 with the longitudinal drum axis 29 disposed therebetween. A central opening 30 is positioned at the longitudinal drum axis 29 for allowing access to the agitator 14 for causing rotation thereof. The central opening 30 is defined by an annular flange 32 that is attached to the surrounding sheet material of the head wall 22. The annular flange 32 may include internal threads 34 (FIG. 3) for allowing attachment of the agitator mounting assembly 16.

Referring now to the agitator 14, the central opening 30 provides for the access to the agitator 14 when positioned in the drum 12 with the head wall 22 coupled to the side wall 20. The agitator 14 includes both a shaft 50 and an impeller 60. The shaft 50 is typically aligned in the drum 12 to extend axially along the longitudinal drum axis 29. The shaft 50 may be of any suitable shape, and may be solid, partially hollow, or hollow along its full axial length. The depicted shaft 50 has a quadrilateral, such as a square, cross-section. A typical material from which the shaft 50 is made is steel, although alternative materials also may be suitable.

The impeller 60 has an impeller body 70 that is configured for imparting an upward movement of the fluid in the container when the agitator 14 is rotated. The depicted impeller body 70 is made of steel, although other metals may be suitable.

The impeller body 70 is defined by a hub portion 72 and a plurality of blades 74 extending radially outwardly from a longitudinal hub axis 76 of the hub portion 72. The longitudinal hub axis 76 and the longitudinal drum axis 29 are co-axial with one another when the agitator 14 is aligned in the drum 12 via the agitator mounting assembly 16. The hub portion 72 has a central recess 78 into which a distal end 51 of the shaft 50 is received and coupled by any suitable means, such as welding.

The depicted impeller 60 includes a pair of opposed blades 74 extending outwardly from the hub portion 72 in opposite directions along a lateral blade axis 80. The lateral blade axis 80 is generally disposed orthogonal to the longitudinal hub axis 76. The shape of the blades 74 is configured for imparting the upward movement of fluid in the drum 12 towards the head wall 22 to adequately agitate the full volume of fluid in the drum 12. Each of the depicted blades 74 is of identical shape and configuration, although alternate configurations may be suitable for imparting the upward movement of fluid in the drum 12.

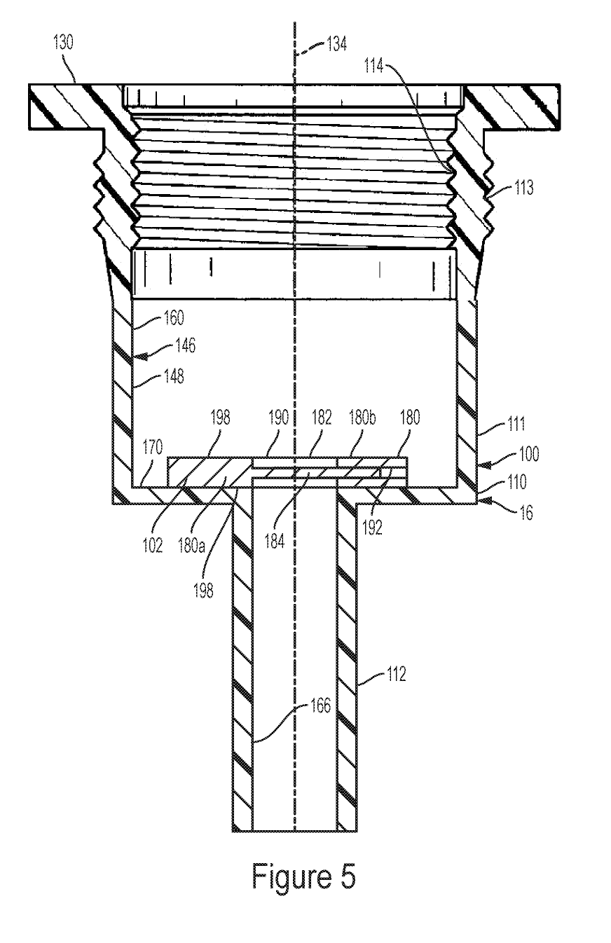

Turning now to FIGS. 3 to 5, the agitator mounting assembly 16 is provided for supporting the agitator 14 to allow the agitation of fluid in the drum 12. The agitator mounting assembly 16, also herein referred to as a mounting assembly 16, includes both an annular base member 100, received in the central opening 30 of the head wall 22 and through the annular flange 32, and a coupling member 102 received into the annular base member 100.

The annular base member 100, also herein referred to as a base member 100, is removably couplable to the drum 12 and provides for access to the shaft 50 of the agitator 14 when the agitator 14 is located in the drum 12. The depicted annular base member 100 is a single piece of unitary construction, being a single, whole section, not including joined parts. In one embodiment, the annular base member 100 is a molded article having unitary construction, in that it is formed as a single piece. For example, the one-piece part can be made preferably of a single material, e.g., a synthetic polymer such as nylon, with a molding process, such as an injection molding process. It is noted that a non-steel material of the annular base member 100 reduces metal-to metal in the container assembly 10. Other molding processes also may be suitable. Alternative suitable manufacturing processes may include additive manufacturing or electrical discharge machining. Likewise, other materials may be suitable in other embodiments, such as the base member 100 and/or coupling member 102 including a metal.

The illustrated annular base member 100 extends between a proximal end 104 that is external to the drum 12 and a distal end 106 that is disposed within the internal volume of the drum 12 when the base member 100 is coupled to the drum 12. The annular base member 100 includes a base member body 110 having an upper coupling portion 111 adjacent the proximal end 104 and an elongated lower portion 112 adjacent the distal end 106. The elongated lower portion 112 is fully received into the internal volume of the drum 12 through the central opening 30, while the upper coupling portion 111 is partially received into the internal volume of the drum 12 through the central opening 30.

The upper coupling portion 111 is configured for coupling to the head wall 22 and also is configured to allow for attachment of the motive device 18 thereto, though not all such motive devices may require such attachment. An external surface of the upper coupling portion 111 at the proximal end 104 includes external threads 113 for threaded engagement with the internal threads 34 of the annular flange 32. The external threads 113 allow the base member body 110 to be coupled in the central opening 30.

Radially inward of the external threads 113, the upper coupling portion 111 also includes internal threads 114 at an internal surface of the base member body 110 at the proximal end 104. The internal threads 114 may correspond to threads of a mounting component of the motive device 18. When the agitator 14 is not in use, a plug 124 of the agitator mounting assembly 16 may be threadedly engaged with the internal threads 114 to seal the agitator mounting assembly 16 and to seal the central opening 30 of the head wall 22 of the drum 12. A seal, such as an o-ring 126, can be positioned below an upper lip 128 of the plug 124, to provide an improved seal between the plug 124 and a seal seat 129 at a proximal end of the internal threads 114 of the base member body 110. The plug 124 thereby provides for closure of the drum 12.

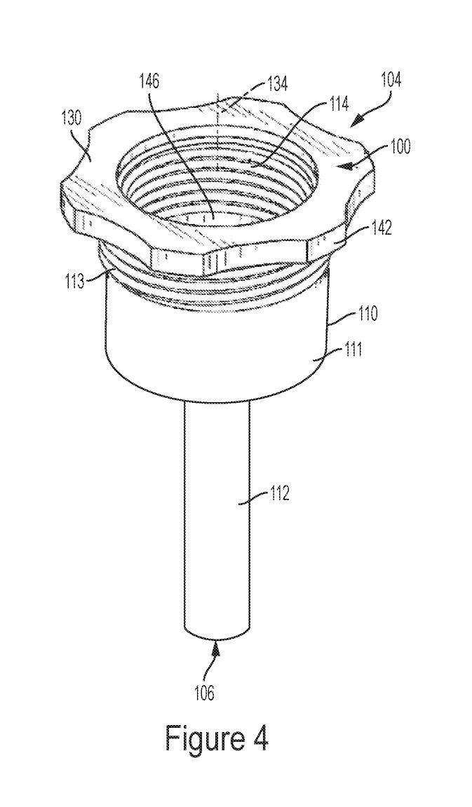

Also at the proximal end 104 of the base member body 110, an upper collar 130 projects radially outwardly from a central opening 132 of the base member body 110 disposed along a central base member longitudinal axis 134. The upper collar 130 acts as a stop surface during threading of the external threads 112 to the internal threads 34 of the annular flange 32. A washer 140, or other suitable sealing component, such as an o-ring, can be provided between an upper surface of the flange 32 and a lower surface of the upper collar 130 of the annular base member 100. The upper collar 130 may be any suitable shape, such as including the depicted circumferentially spaced-apart teeth 142 (FIG. 4), for enabling gripping of the base member body 110, and thus facilitating removal and attachment of the agitator mounting assembly 16 to the annular flange 32.

Each of the upper coupling portion 111 and the elongated lower portion 112 extend along the central base member longitudinal axis 134 and together define an internal cavity 146 of the base member body 110. The internal cavity 146 extends fully through the base member body 110 along the central base member longitudinal axis 134, which is aligned with the longitudinal drum axis 29 when the mounting assembly 16 is coupled to the head wall 22, which is in turn coupled to the side wall 20.

The internal cavity 146 is defined by an internal annular wall 148 that is configured both to support the coupling member 102 and the agitator shaft 50 therein. Particularly, an upper cavity section 160 of the internal cavity 146 is disposed above (or proximal to) a lower cavity section 166.

The lower cavity section 166 of the internal cavity 146 extends through the elongated lower portion 112 of the base member body 110. The lower cavity section 166 is an elongated cavity section configured for receiving and supporting the agitator shaft 50. The internal annular wall 148 of the lower cavity section 166 is configured to radially engage a length of the shaft 50 received therein. For example, the lower cavity section 166 has a cylindrical shape for supporting the corners of the square-cross-section of the shaft 50, to thereby serve as a bearing surface for the length of the shaft 50 received therein.

To provide said support, the lower cavity section 166 has a continuous circular cross-section of constant diameter along a length of the central longitudinal base member axis 134 that provides an elongated bearing surface. In the depicted embodiment, said elongated, constant diameter bearing surface has a greater length than the diameter of the lower cavity section 166, such as having a length at least twice the diameter of the lower cavity section 166. In other embodiments, the length of said elongated, constant diameter bearing surface may be a magnitude greater than twice the diameter of the lower cavity section 166.

Further, as compared to the upper cavity section 160, a cross-sectional area of the lower cavity section 166 orthogonal to the central longitudinal base member axis 134 and taken through a portion (of the lower cavity section 166) receiving the shaft 50 is lesser than a cross-sectional area of the upper cavity section 160 orthogonal to the central longitudinal base member axis 134 and also taken through a portion (of the upper cavity section 160) receiving the shaft.

The upper cavity section 160 is positioned to receive at least a portion of the proximal end 52 of the shaft 50 and at least a portion of the coupling member 102. The upper cavity section 160 is at least partially defined by the internal threads 114. Distal the internal threads 114, a support bearing surface 170 is provided for supporting the coupling member 102 when attached to the agitator shaft 50. The support bearing surface 170 also partially defines the upper cavity section 160 and is a part of the internal annular wall 148.

The depicted support bearing surface 170 is a flat surface disposed orthogonal to the central base member longitudinal axis 134, and is positioned to enable rotation of the coupling member 102 thereon. Accordingly, the shape and position of the depicted support bearing surface 170 corresponds to the coupling member 102, as illustrated in FIG. 3, to provide for adequate bearing support of a surface of the coupling member 102 engaged therewith. Alternative arrangements may be suitable, such as where each of the support bearing surface and the coupling member have corresponding conical shapes (not shown).

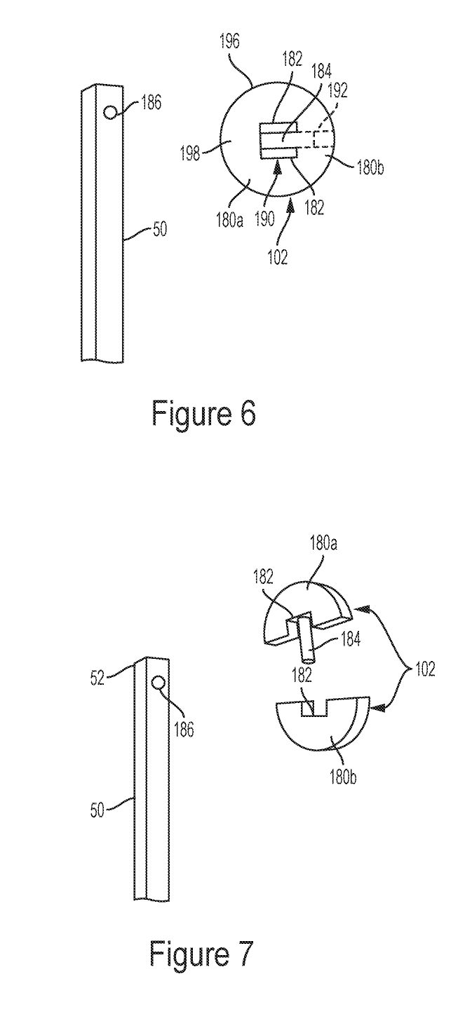

Referring still to FIGS. 3 to 5, the coupling member 102 is likewise configured to be received into the upper cavity section 160 of the annular base member 100, after being removably coupled to the shaft 50 of the agitator 14, as mentioned above. The depicted coupling member 102 is made from a plastic, such as nylon. The coupling member 102 includes at least one body section 180 having a recess portion 182 for receiving the shaft 50. The coupling member 102 also includes a pin portion 184 for being received by a corresponding slot 186 (FIG. 6) of the shaft 50, for retaining the shaft 50 relative to the coupling member 102 (or vice versa).

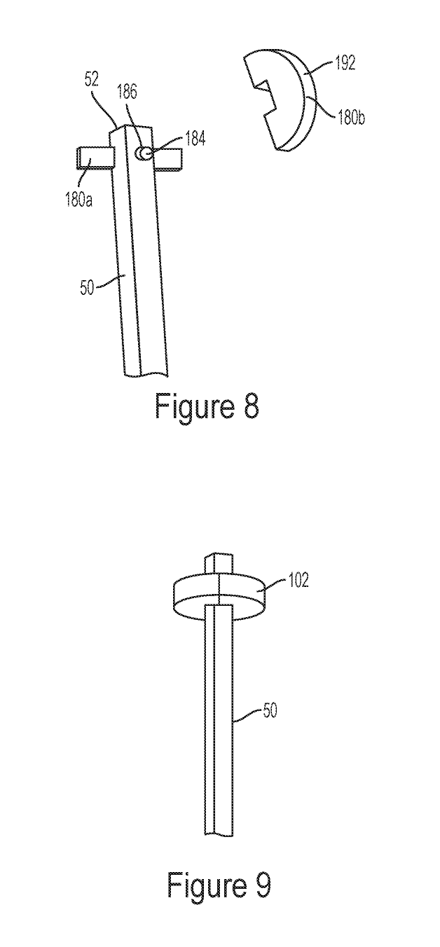

Turning now to FIGS. 6 to 9, the depicted coupling member 102 includes a pair of oppositely disposed body sections 180 that are interengageable with one another to capture the shaft 50 therebetween. Each coupling member body section 180 includes a recess portion 182 for receiving the shaft 50. When interengaged, the recess portions 182 define a whole recess 190 through which the shaft 50 may be disposed. The illustrated recess 190 has a square cross-section corresponding to the square cross-section of the shaft 50, for aiding in preventing movement of the coupling member 102 relative to the shaft 50 when interengaged therewith.

The pin portion 184 is fixed to and extends into the recess portion 182 of a first of the coupling member body sections 180a, such as centrally through. The pin portion 184 is illustrated as being a cylindrical member that is shaped to be received by the shaft slot 186, which also has a cylindrical shape, although alternative corresponding shapes may be suitable. The shaft slot 186 is generally aligned orthogonal to a longitudinal shaft axis 190 of the agitator 14 at the proximal end 52 of the shaft 50.

The receipt of the pin portion 184 into the shaft slot 186 fixes at least the first coupling member body section 180a relative to the shaft 50. The second coupling member body section 180b also is fixed relative to the shaft 50 and relative to the first coupling member body section 180a. This fixative coupling is enabled via receipt of the pin portion 184 into a coupling member slot 192 extending into the second coupling member body section 180b. Accordingly, when each of the body sections 180 are interengaged with one another and with the shaft 50, the pin portion 184 of the first coupling member body section 180a is received into both the shaft 50 (shaft slot 186) and the second coupling member body section 180b (coupling member slot 192). In other embodiments, two or more pin portions and corresponding shaft and coupling member slots may be included.

The illustrated coupling member slot 192 has a cylindrical shape corresponding to the cylindrical shape of the pin portion 184, although alternative corresponding shapes may be suitable. The coupling member slot 192 is depicted as extending from the recess portion 182 of the second body section 180b, fully through the second body section 180b, and to an outer periphery of the second body section 180b. When the body sections 180 (180a and 180b) are interengaged, the depicted pin portion 184 is disposed along less than a full length of the coupling member slot 192, though other extents (lesser or greater) of the pin portion 184 into the coupling member slot 192 may be suitable. Additionally or alternatively, the coupling member slot 192 may extend less than fully through the second body section 180b.

The assembled coupling member 102 resembles a disc having a thickness dimension alignable along the longitudinal shaft axis 190. The thickness dimension is lesser than a longest diameter across the coupling member 102 in a direction orthogonal to the thickness dimension. An outer periphery 196 of the assembled coupling member 102 is circular and corresponds to a circular cross-sectional shape of the upper cavity section 160 of the internal cavity 146 of the annular base member 100. A diameter of the disc-shaped assembled coupling member 102 is less than an internal diameter of the upper cavity section 160 of the base member 100.

The outer periphery 196 extends between oppositely disposed end faces 198 of the assembled coupling member 102. The depicted end faces 198 each are equivalent in shape and surface area and are aligned along planes that are orthogonal to a central pin axis of the pin portion 184. The end faces 198 are orthogonally alignable relative to the longitudinal shaft axis 190 when the coupling member 102 is received into the upper cavity section 160.

Referring still to FIGS. 6-9, but also again to both FIG. 1 and FIG. 3 showing portions of the full container assembly 10 of the present invention, the coupling member 102 and annular base member 100 of the agitator mounting assembly 16 are jointly configured to be interengageable to thereby align the agitator 14 along a central longitudinal drum axis 29. To use the agitator 14 as shown in FIG. 1, the annular base member 100 is threadedly coupled to the head wall 22 of the drum 12. The plug 124 is removed from the annular base member 100. The proximal end 52 of the shaft 50 of the agitator 14 is inserted into the distal end 106 and elongated lower portion 112 of the base member body 110, and particularly into and fully through the lower cavity section 166.

The proximal end face of the proximal end 52 of the shaft 50 is at least partially received into the upper cavity section 160. The proximal end 52 includes the shaft slot 186 extending therethrough. The first coupling member body section 180a is fixed to the shaft 50 via receipt of the pin portion 184 into the shaft slot 186. The second coupling member body section 180b is fixed relative to the shaft 50 and relative to the first body section 180a by engagement of the pin portion 184 into the coupling member slot 192 of the second body section 180b. At this stage, the assembled coupling member 102 is fixed relative to the agitator 14.

The shaft 50 is lowered distally along the central longitudinal body member axis 134 until the assembled coupling member 102 fixed thereto is received fully into the upper cavity section 160 of the internal cavity 146 of the annular base member 100. The respective planes of the end faces 198 are aligned orthogonal to the base member longitudinal axis 134. One end face 198 of the assembled coupling member 102 is engaged against the support bearing surface 170. When the coupling member 102 is supported against the support bearing surface 170, the length of the shaft 50 received into the lower cavity section 166 is distally axially spaced from the proximal end 52 of the shaft 50 that is coupled to the coupling member 102.

At this stage, the sub-assembly of the agitator 14, agitator mounting assembly 16, and head wall 22 may be lowered towards the remainder of the drum 12 (side wall 20 and bottom wall 24) such that the agitator 14 is lowered into the internal volume of the drum 12. The head wall 22 is connected to the cylindrical side wall 20 such that the elongated lower portion 112 of the annular base member 100 is fully retained in the internal volume of the drum 12.

As shown in FIGS. 1 to 3, the internal support bearing surface 170 serves as a bearing surface for the coupling member 102 during joint rotation of the coupling member 102 and the agitator 14. In the illustrated embodiment, the internal support bearing surface 170 and the full body of the assembled coupling member 102 are fully retained below the head wall 22, generally within the internal volume of the drum 12. Alternative constructions of the annular base member 100, such as with the external threads 113 disposed axially distal (below) the internal support bearing surface 170, may be suitable in other embodiments.

With the head wall 22 coupled to the remainder of the drum 12, the agitator 14 is hung in the drum 12, with the agitator shaft 50 being aligned along the central longitudinal drum axis 29. The agitator 14 is supported in this manner for its rotation within the drum 12 to cause agitation of fluid in the internal volume of the drum 12. Radial and angular deviation of the shaft 50 relative to the central longitudinal drum axis 29 is restricted due to the surfaces of the lower cavity section 166 of the elongated lower portion 112 serving as a rotational bearing support for the shaft 50.

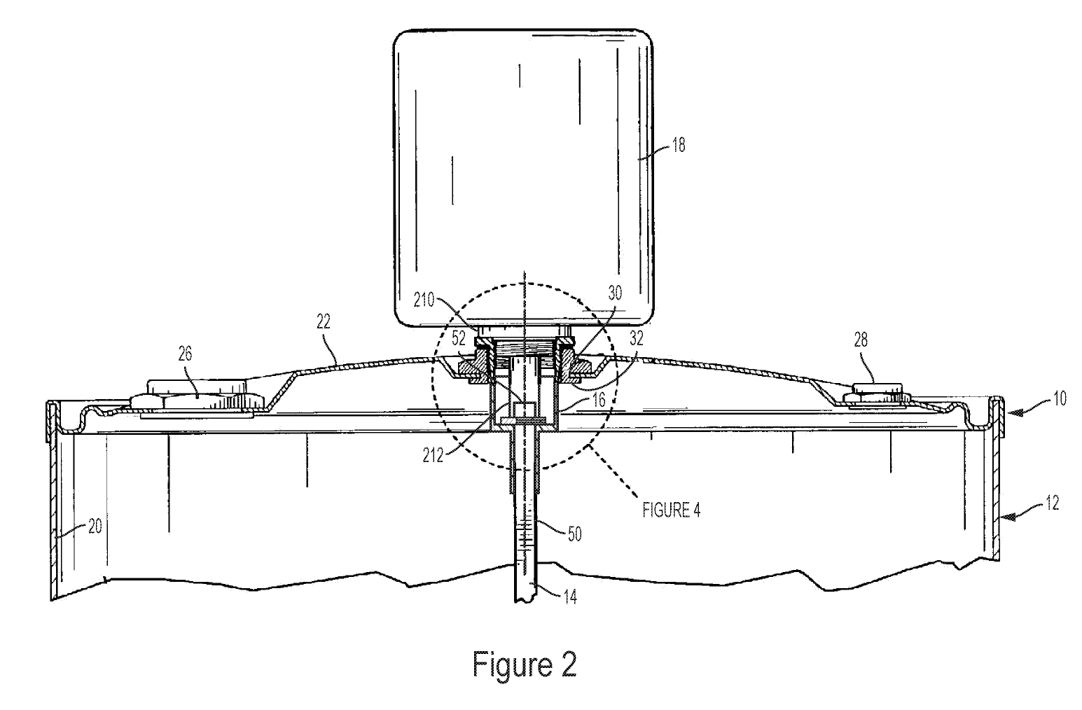

To cause rotation of the agitator 14, the motive device 18, such as the powered motive device 18 depicted in FIG. 2, is mounted to the upper coupling portion 111 of the annular base member 100. A mounting component 210 of the powered motive device 18 is threadedly coupled to the internal threads 114. A coupling sleeve 212 of the powered motive device 18 is engaged with, such as disposed about, the proximal end 52 of the shaft 50 axially proximal to the coupling member 102 attached thereto. Accordingly, rotation of the coupling sleeve 212 by the powered motive device 18 causes agitation of the fluid contained in the drum 12 via corresponding rotation of the hanging agitator 14.

The hanging of the agitator 14 from the agitator mounting assembly 16 offsets the impeller 60 of the agitator 14 from an internal lower surface 204 of the drum 12 (internal surface of the bottom wall 24). Accordingly, the lower end of the agitator 14 does not need to be supported for rotational movement at a lower portion of the drum 12, such as via a pivot pin disposed opposite the central opening 30, as is conventionally contemplated. Omission of such a pivot pin attached to the bottom wall 24 of the drum 12 beneficially reduces the need for welding such a pivot pin to the bottom wall 24.

Further, absent need for the pivot pin, the agitator 14 may be more easily positioned in the drum 12. Conventionally, the impeller 60 must first be aligned along a pivot pin projecting from the bottom wall 24 of the drum 12, while the head wall 22 is not coupled to the side wall 20. The head wall 22 must then be attached while still maintaining alignment of the proximal end 52 of the shaft 50 with the central opening 30 of the head wall 22 and the annular flange 32. This alignment step can be unnecessarily complex and is unnecessary in view of the beneficial hanging of the agitator 14 from the agitator mounting assembly 16 as described herein.

In summary, an agitator mounting assembly 16 is provided for hanging an agitator 14 relative to a container 12 for enabling rotation of the agitator 14 to agitate fluid in a container 12. The agitator mounting assembly 16 is configured to align the agitator 14 both radially relative to and longitudinally along a central longitudinal container axis 29 of the container 12. The agitator mounting assembly 16 includes an annular base member 100 and a coupling member 102 that cooperatively engage one another to hang the agitator 14 relative to the container 12. The annular base member 100 is removably coupleable to the container 12 and provides for access to a shaft 50 of the agitator 14 disposed in the container 12. The coupling member 102 is removably couplable to the shaft 50 and is supported by the annular base member 100 when coupled to the shaft 50 to thereby support the hanging of the agitator 14 from the agitator mounting assembly 16.

The present disclosure also includes a method of mounting an agitator 14 to a container 12 using an agitator mounting assembly 16 having an annular base member 100 and a coupling member 102 receivable into the annular base member 100. The method includes the steps of: (a) threadedly coupling the annular base member 100 to the container 12, (b) receiving a proximal end 52 of a shaft 50 of the agitator 14 into the annular base member 100, (c) coupling the coupling member 102 about the proximal end 52 of the shaft 50 of the agitator 14 and into a slot 186 of the shaft 50, and (d) supporting the coupling member 102 against a support surface 170 of an internal cavity 146 of the annular base member 100, thereby enabling the shaft 50 coupled thereto to be hung relative to the annular base member 100. The hanging of the shaft 50 relative to the annular base member 100 includes hanging the shaft 50 spaced from a lower surface 204 of the drum 12 for rotation of the agitator 14 while spaced from the lower surface 204.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

Use of the terms “upper,” “lower,” “above”, “below,” and corresponding equivalents are not dispositive of necessary alignment of the respective components for functional use thereof. Rather, the designations are assigned relative to the disposition of the respective components as illustrated in the figures, unless otherwise indicated.

All ranges and ratio limits disclosed in the specification and claims may be combined in any manner. It is to be understood that unless specifically stated otherwise, references to “a,” “an,” and/or “the” may include one or more than one, and that reference to an item in the singular may also include the item in the plural.

The phrase “and/or” should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The word “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” may refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

The phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The transitional words or phrases, such as “comprising,” “including,” “carrying,” “having,” “containing,” “involving,” “holding,” and the like, are to be understood to be open-ended, i.e., to mean including but not limited to.

What is claimed is:

1. An agitator mounting assembly couplable to a container for mounting an agitator in the container, the agitator mounting assembly, comprising:
an annular base member being removably couplable to the container and providing for access to a shaft of the agitator disposed in the container; and
a coupling member removably couplable to the shaft, the coupling member being supported by the annular base member when coupled to the shaft to thereby support hanging of the agitator from the agitator mounting assembly.

2. The agitator mounting assembly of claim 1, wherein the annular base member has a cavity extending fully therethrough along a longitudinal base member axis, an elongated lower portion of the cavity having a continuous circular cross-section of constant diameter along a length of the longitudinal base member axis that is at least twice a diameter of the lower portion of the cavity to radially support a length of the shaft received therein.

3. The agitator mounting assembly of claim 1, wherein the annular base member includes an annular internal wall defining an elongated cavity extending therethrough for receiving and supporting the shaft, and wherein the annular internal wall is configured to radially engage a length of the shaft received therein that is axially spaced from a proximal end of the shaft couplable to the coupling member to serve as a bearing surface for said length of the shaft.

4. The agitator mounting assembly of claim 1, wherein the hanging includes aligning the shaft of the agitator along a longitudinal base member axis of the annular base member.

5. The agitator mounting assembly of claim 1, wherein the annular base member has an internal bearing surface against which the coupling member is engaged for supporting rotation of the coupling member with the agitator when the coupling member is coupled to the agitator.

6. The agitator mounting assembly of claim 1, wherein the annular base member is configured to receive and to retain the coupling member completely within a cavity of the annular base member.

7. The agitator mounting assembly of claim 1, wherein the coupling member includes a pin portion configured to be received into a corresponding slot of the shaft for retaining the shaft relative to the coupling member.

8. The agitator mounting assembly of claim 1, wherein the coupling member includes a pair of oppositely disposable sections engageable with one another with the shaft disposable therebetween for retaining the shaft relative to the coupling member.

9. The agitator mounting assembly of claim 1, wherein the annular base member is a single molded article of unitary construction.

10. The agitator mounting assembly of claim 1, in combination with the agitator and the container, wherein the coupling member is attached to the shaft of the agitator and the coupling member is retained by the annular base member, and wherein the annular base member and coupling member are jointly configured to align the agitator along a central longitudinal container axis of the container.

11. An agitator mounting assembly couplable to a container for mounting an agitator in the container, the agitator mounting assembly, comprising:
an annular base member having a cavity extending fully therethrough along a longitudinal base member axis, the annular base member being removably couplable to the container and shaped to receive a shaft of the agitator therein;
a coupling member removably couplable to the shaft of the agitator and receivable into the cavity of the annular base member, wherein the annular base member has an inner support surface at least partially defining the cavity, wherein the inner support surface is located for engagement by the coupling member to support the coupling member during rotation with the shaft, and wherein the shaft is axially aligned along the longitudinal base member axis
wherein an interengagement of the shaft with the coupling member and the coupling member with the annular base member aligns the agitator along the longitudinal base member axis such that the agitator may be offset from a lower surface of the container.

12. The agitator mounting assembly of claim 11, wherein the annular base member has a distal section received into the container that at least partially defines the cavity, and wherein an elongated portion of the cavity defined by the distal section is a cylindrical passage engageable by the shaft of the agitator to provide a longitudinal bearing surface having a greater length than a diameter of the cylindrical passage.

13. The agitator mounting assembly of claim 11, wherein the annular base member cavity includes a proximal section receiving the coupling member and a distal section adjacent the proximal section, the distal section and the proximal section each receiving the shaft, wherein a cross-sectional area of the upper section orthogonal to the longitudinal base member axis and taken through a portion receiving the shaft is greater than a cross-sectional area of the lower section orthogonal to the longitudinal base member axis and taken through a portion receiving the shaft.

14. The agitator mounting assembly of claim 11, wherein the coupling member includes a pin portion configured to be received into a corresponding slot of the shaft for retaining the shaft relative to the coupling member.

15. The agitator mounting assembly of claim 11, wherein the coupling member includes a pair of oppositely disposable sections engageable with one another with the shaft disposed therebetween for retaining the shaft relative to the coupling member.

16. The agitator mounting assembly of claim 11, wherein the cavity of the annular base member is configured such that the coupling member is positioned within the container.

17. The agitator mounting assembly of claim 11, wherein the annular base member is a single molded article of unitary construction.

18. The agitator mounting assembly of claim 11, in combination with the agitator and the container, wherein the coupling member is attached about the shaft of the agitator and the coupling member is retained within the annular base member, and wherein the annular base member and coupling member are interengageable to align the agitator along a central longitudinal container axis of the container.

19. A method of mounting an agitator to a container using an agitator mounting assembly having an annular base member and a coupling member receivable into the annular base member, the method comprising the steps of:
threadedly coupling the annular base member to the container;
receiving a proximal end of a shaft of the agitator into the annular base member;
coupling the coupling member about the proximal end of the shaft of the agitator and into a slot of the shaft; and
supporting the coupling member against a support surface of an internal cavity of the annular base member, thereby enabling the shaft coupled thereto to be hung relative to the annular base member.

20. The method of claim 19, wherein the hanging of the shaft relative to the annular base member includes hanging the shaft spaced from a lower surface of the drum for rotation of the agitator while spaced from the lower surface.
